(19) United States
(12) Patent Application Publication
(10) Pub. No.: US 2023/0392997 A1
(43) Pub. Date: Dec. 7, 2023

(54) LOAD SENSOR

(71) Applicant: Panasonic Intellectual Property Management Co., Ltd., Osaka (JP)

(72) Inventors: Yuta MORIURA, Osaka (JP); Susumu URAGAMI, Osaka (JP); Takashi MATSUMOTO, Osaka (JP); Yodai MATSUMURA, Osaka (JP); Hiroyki FURUYA, Osaka (JP); Yui AIHARA, Osaka (JP)

(21) Appl. No.: 18/236,745

(22) Filed: Aug. 22, 2023

Related U.S. Application Data
(63) Continuation of application No. PCT/JP22/03793, filed on Feb. 1, 2022.

(30) Foreign Application Priority Data
Feb. 25, 2021 (JP) 2021-028567

(51) Int. Cl. G01L 1/14

(52) U.S. Cl. CPC G01L 1/14

(57) ABSTRACT

A load sensor includes: a first base member and a second base member disposed so as to face each other; an electrically-conductive elastic body disposed on an opposing face of the first base member; an electrically-conductive member having a linear shape and disposed between the second base member and the electrically-conductive elastic body; and a dielectric body disposed between the electrically-conductive elastic body and the electrically-conductive member. The electrically-conductive member has a bent shape that is bent in a direction toward the electrically-conductive elastic body.

### CROSS REFERENCE TO RELATED APPLICATION

This application is a continuation of International Application No. PCT/JP2022/003793 filed on Feb. 1, 2022, entitled “LOAD SENSOR”, which claims priority under 35 U.S.C. Section 119 of Japanese Patent Application No. 2021-028567 filed on Feb. 25, 2021, entitled “LOAD SENSOR”. The disclosures of the above applications are incorporated herein by reference.

### BACKGROUND OF THE INVENTION

### Field of the Invention

The present invention relates to a load sensor that detects a load applied from outside, based on change in capacitance.

### Description of Related Art

Load sensors are widely used in the fields of industrial apparatuses, robots, vehicles, and the like. In recent years, in accordance with advancement of control technologies by computers and improvement of design, development of electronic apparatuses that use a variety of free-form surfaces such as those in human-form robots and interior equipment of automobiles is in progress. In association therewith, it is required to mount a high performance load sensor to each free-form surface.

International Publication No. WO2018/096901 describes a pressure sensitive element including: a first electrically-conductive member formed from an electrically-conductive rubber having a sheet shape; a second electrically-conductive member having a linear shape and sandwiched by the first electrically-conductive member and a base member; and a dielectric body formed so as to cover the second electrically-conductive member. In this configuration, in association with increase in the load, the contact area between the first electrically-conductive member and the dielectric body increases, and in association with this, the capacitance between the first electrically-conductive member and the second electrically-conductive member increases. Therefore, when the value of the capacitance between the first electrically-conductive member and the second electrically-conductive member is detected, the load applied to the pressure sensitive element can be detected.

However, in the above configuration, since the first electrically-conductive member is deformed only in the circumferential direction of the second electrically-conductive member in accordance with increase in the load, the relationship between the load and the capacitance has a curved shape. In order to appropriately detect change in the capacitance according to the load through simple processing, it is preferable that the relationship between the load and the capacitance has a straight line shape.

### SUMMARY OF THE INVENTION

A main aspect of the present invention relates to a load sensor. A load sensor according to the present aspect includes: a first base member and a second base member disposed so as to face each other; an electrically-conductive elastic body disposed on an opposing face of the first base member; an electrically-conductive member having a linear shape and disposed between the second base member and the electrically-conductive elastic body; and a dielectric body disposed between the electrically-conductive elastic body and the electrically-conductive member. The electrically-conductive member has a bent shape that is bent in a direction toward the electrically-conductive elastic body.

In the load sensor according to the present aspect, the electrically-conductive member has a bent shape. Thus, when a load is applied, the electrically-conductive elastic body is deformed not only in the circumferential direction of the electrically-conductive member but also, along the bent shape, in the length direction of the electrically-conductive member. Therefore, when compared with a case where the electrically-conductive member is not bent, change in the capacitance with respect to the load is less likely to be saturated, and the form of this change can be made closer to that of a straight line.

The effects and the significance of the present invention will be further clarified by the description of the embodiments below. However, the embodiments below are merely examples for implementing the present invention. The present invention is not limited to the embodiments below in any way.

### BRIEF DESCRIPTION OF THE DRAWINGS

FIG. 1A is a perspective view schematically showing a base member on the lower side and electrically-conductive elastic bodies set on an opposing face of the base member on the lower side, according to Embodiment 1;

FIG. 1B is a perspective view schematically showing conductor wires, insulation members, and threads, according to Embodiment 1;

FIG. 2A and FIG. 2B each schematically show a procedure of creating a structure composed of the conductor wires and the insulation members, according to Embodiment 1;

FIG. 3A is a perspective view schematically showing a base member on the upper side and electrically-conductive elastic bodies set on an opposing face of the base member on the upper side, according to Embodiment 1;

FIG. 3B is a perspective view schematically showing a load sensor of which assembly has been completed, according to Embodiment 1;

FIG. 4A and FIG. 4B are each a cross-sectional view schematically showing the vicinity of an intersection between electrically-conductive elastic bodies and a conductor wire when viewed in the Y-axis positive direction, according to Embodiment 1;

FIG. 5A and FIG. 5B are each a cross-sectional view schematically showing the vicinity of an intersection between electrically-conductive elastic bodies and conductor wires when viewed in the X-axis negative direction, according to Embodiment 1;

FIG. 6 is a plan view schematically showing a configuration of the inside of the load sensor, according to Embodiment 1;

FIG. 7A and FIG. 7B each schematically show a configuration of a load sensor of an embodiment used in verification, according to verification of Embodiment 1;

FIG. 8A and FIG. 8B each schematically show a configuration of a load sensor of Comparative Example used in verification, according to verification of Embodiment 1;

FIG. 9 is a graph showing a relationship between load and capacitance obtained in verification, according to verification in Embodiment 1;

FIG. 10A and FIG. 10B are each a cross-sectional view schematically showing the vicinity of an intersection between an electrically-conductive elastic body and a conductor wire, according to Embodiment 2;

FIG. 11 is a plan view schematically showing a configuration of the inside of a load sensor, according to Embodiment 2;

FIG. 12 is a cross-sectional view schematically showing the vicinity of an intersection between electrically-conductive elastic bodies and a conductor wire, according to Embodiment 3;

FIG. 13A and FIG. 13B are each a cross-sectional view schematically showing the vicinity of an intersection between electrically-conductive elastic bodies and a conductor wire, according to Embodiment 4;

FIG. 14 is a perspective view schematically showing a configuration in which conductor wires are disposed, according to Embodiment 4; and

FIG. 15A and FIG. 15B are each a cross-sectional view schematically showing the vicinity of an intersection between electrically-conductive elastic bodies and an electrically-conductive member, according to Embodiment 5;

It is noted that the drawings are solely for description and do not limit the scope of the present invention in any way.

### DETAILED DESCRIPTION

The load sensor according to the present invention is applicable to a load sensor of a management system or an electronic apparatus that performs processing in accordance with an applied load.

Examples of the management system include a stock management system, a driver monitoring system, a coaching management system, a security management system, and a caregiving/nursing management system.

In the stock management system, for example, by a load sensor provided to a stock shelf, the load of a placed stock is detected, and the kinds of commodities and the number of commodities present on the stock shelf are detected. Accordingly, in a store, a factory, a warehouse, and the like, the stock can be efficiently managed, and manpower saving can be realized. In addition, by a load sensor provided in a refrigerator, the load of food in the refrigerator is detected, and the kinds of the food and the quantity and amount of the food in the refrigerator are detected. Accordingly, a menu that uses food in a refrigerator can be automatically proposed.

In the driver monitoring system, by a load sensor provided to a steering device, the distribution of a load (e.g., gripping force, grip position, tread force) applied to the steering device by a driver is monitored, for example. In addition, by a load sensor provided to a vehicle-mounted seat, the distribution of a load (e.g., the position of the center of gravity) applied to the vehicle-mounted seat by the driver in a seated state is monitored. Accordingly, the driving state (sleepiness, mental state, and the like) of the driver can be fed back.

In the coaching management system, for example, by a load sensor provided to the bottom of a shoe, the load distribution at a sole is monitored. Accordingly, correction or guidance to an appropriate walking state or running state can be realized.

In the security management system, for example, by a load sensor provided to a floor, the load distribution is detected when a person passes, and the body weight, stride, passing speed, shoe sole pattern, and the like are detected. Accordingly, the person who has passed can be identified by checking these pieces of detection information against data.

In the caregiving/nursing management system, for example, by load sensors provided to bedclothes and a toilet seat, the distributions of loads applied by a human body to the bedclothes and the toilet seat are monitored. Accordingly, at the positions of the bedclothes and the toilet seat, what action the person is going to take is estimated, whereby tumbling or falling can be prevented.

Examples of the electronic apparatus include a vehicle-mounted apparatus (car navigation system, audio apparatus, etc.), a household electrical appliance (electric pot, IH cooking heater, etc.), a smartphone, an electronic paper, an electronic book reader, a PC keyboard, a game controller, a smartwatch, a wireless earphone, a touch panel, an electronic pen, a penlight, lighting clothes, and a musical instrument. In an electronic apparatus, a load sensor is provided to an input part that receives an input from a user.

The load sensors in the embodiments below are each a capacitance-type load sensor that is typically provided in a load sensor of a management system or an electronic apparatus as described above. Such a load sensor may be referred to as a “capacitance-type pressure-sensitive sensor element”, a “capacitive pressure detection sensor element”, a “pressure-sensitive switch element”, or the like. The load sensor in the embodiments below is connected to a detection circuit, and the load sensor and the detection circuit form a load detection device. The embodiments below are examples of embodiments of the present invention, and the present invention is not limited to the embodiments below in any way.

Hereinafter, embodiments of the present invention will be described with reference to the drawings. For convenience, X-, Y-, and Z-axes orthogonal to each other are indicated in the drawings. The Z-axis direction is the height direction of a load sensor 1.

### Embodiment 1

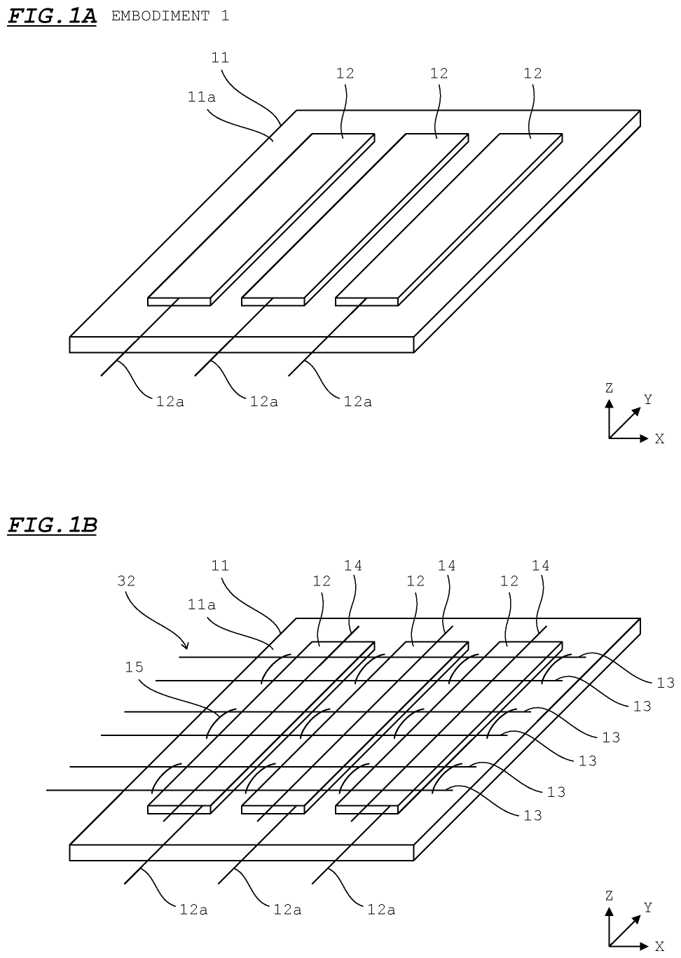

A configuration of the load sensor 1 will be described with reference to FIG. 1A to FIG. 6.

FIG. 1A is a perspective view schematically showing a base member 11, and electrically-conductive elastic bodies 12 set on an opposing face 11a (the face on the Z-axis positive side) of the base member 11.

The base member 11 is an insulative member having elasticity, and has a flat plate shape parallel to an X-Y plane. The thickness in the Z-axis direction of the base member 11 is mm to 2 mm, for example. The elastic modulus of the base member 11 is 0.01 MPa to 10 MPa, for example.

The base member 11 is formed from a non-electrically-conductive resin material or a non-electrically-conductive rubber material. The resin material used in the base member 11 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. The rubber material used in the base member 11 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive elastic bodies 12 are formed on the opposing face 11a (the face on the Z-axis positive side) of the base member 11. In FIG. 1A, three electrically-conductive elastic bodies 12 are formed on the opposing face 11a of the base member 11. Each electrically-conductive elastic body 12 is an electrically-conductive member having elasticity. The electrically-conductive elastic bodies 12 each have a band-like shape that is long in the Y-axis direction, and are formed so as to be arranged with a predetermined interval therebetween in the X-axis direction. At an end portion on the Y-axis negative side of each electrically-conductive elastic body 12, a cable 12a electrically connected to the electrically-conductive elastic body 12 is set.

The width in the X-axis direction of each electrically-conductive elastic body 12 is 2 mm to 50 mm, for example, and the gap between adjacent electrically-conductive elastic bodies 12 is 1 mm to 5 mm, for example. As an example, the width in the X-axis direction of each electrically-conductive elastic body 12 is 10 mm, and the gap between adjacent electrically-conductive elastic bodes 12 is 2 mm. The elastic modulus of the electrically-conductive elastic body 12 is 0.1 MPa to 10 MPa, for example. The electric resistivity of the electrically-conductive elastic body 12 is not greater than 100 Ω·cm, for example.

Each electrically-conductive elastic body 12 is formed on the opposing face 11a of the base member 11 by a printing method such as screen printing, gravure printing, flexographic printing, offset printing, or gravure offset printing. With these printing methods, the electrically-conductive elastic body 12 can be formed so as to have a thickness of about 0.001 mm to 0.5 mm on the opposing face 11a of the base member 11.

Each electrically-conductive elastic body 12 is formed from a resin material and an electrically-conductive filler dispersed therein, or from a rubber material and an electrically-conductive filler dispersed therein.

Similar to the resin material used in the base member 11 described above, the resin material used in the electrically-conductive elastic body 12 is a resin material of at least one type selected from the group consisting of a styrene-based resin, a silicone-based resin (polydimethylpolysiloxane (e.g., PDMS)), an acrylic resin, a rotaxane-based resin, a urethane-based resin, and the like, for example. Similar to the rubber material used in the base member 11 described above, the rubber material used in the electrically-conductive elastic body 12 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive filler used in the electrically-conductive elastic body 12 is a material of at least one type selected from the group consisting of: metal materials such as Au (gold), Ag (silver), Cu (copper), C (carbon), ZnO (zinc oxide), In₂O₃ (indium oxide (III)), and SnO₂ (tin oxide (IV)); electrically-conductive macromolecule materials such as PEDOT:PSS (i.e., a complex composed of poly(3,4-ethylenedioxythiophene) (PEDOT) and polystyrene sulfonate (PSS)); electrically-conductive fibers such as a metal-coated organic matter fiber and a metal wire (fiber state); and the like, for example.

FIG. 1B is a perspective view schematically showing conductor wires 13, insulation members 1, and threads 15 disposed on the structure in FIG. 1A.

Each conductor wire 13 and each insulation member 14 have a line shape. Each conductor wire 13 extends in the X-axis direction, and each insulation member 14 extends in the Y-axis direction. The conductor wires 13 are disposed so as to be arranged in the Y-axis direction with a predetermined interval therebetween. The insulation members 14 are arranged in the X-axis direction with a predetermined interval therebetween, and are each disposed at the center in the X-axis direction of a corresponding electrically-conductive elastic body 12. In FIG. 1B, six conductor wires 13 and three insulation members 14 are combined so as to form a net (mesh structure), thereby forming a net-like (mesh-like) structure 32.

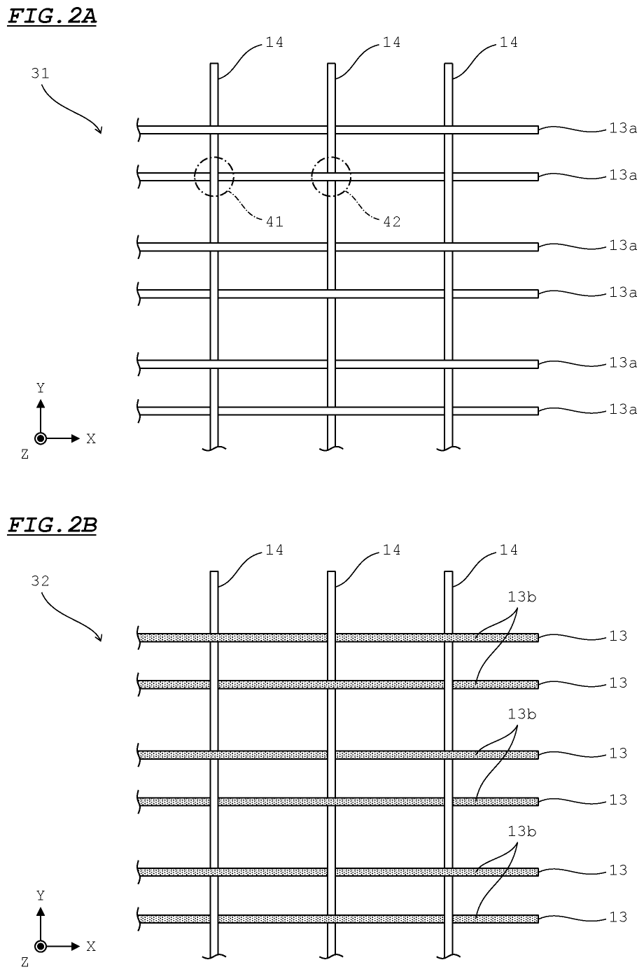

FIGS. 2A, 2B each schematically show a procedure of creating the structure 32.

As shown in FIG. 2A, a plurality of the electrically-conductive members 13a and a plurality of the insulation members 14 are disposed so as to cross perpendicularly to each other. At this time, the plurality of the electrically-conductive members 13a and the plurality of the insulation members 14 are assembled in a matrix shape such that, at a plurality of intersections at each of which an electrically-conductive member 13a and an insulation member 14 cross each other, an intersection 41 at which an electrically-conductive member 13a is positioned below (the Z-axis negative side) an insulation member 14, and an intersection 42 at which an electrically-conductive member 13a is positioned above (the Z-axis positive side) an insulation member 14 are alternately disposed in the X-axis direction and in the Y-axis direction.

Each electrically-conductive member 13a is formed from an electrically-conductive metal material, for example. Other than this, the electrically-conductive member 13a may be composed of a core wire made of glass, and an electrically-conductive layer formed on the surface of the core wire. Alternatively, the electrically-conductive member 13a may be composed of a core wire made of resin, and an electrically-conductive layer formed on the surface of the core wire. In Embodiment 1, the electrically-conductive member 13a is formed from aluminum. The gap between adjacent electrically-conductive members 13a is 5 mm, for example.

Each insulation member 14 is an insulative member and is formed from an acrylic resin or a nylon resin, for example. The gap between adjacent insulation members 14 is set to, for example, a value obtained by adding the width in the X-axis direction of an electrically-conductive elastic body 12 and the gap between adjacent electrically-conductive elastic bodies 12, and is 12 mm, as an example.

Then, a plurality of the electrically-conductive members 13a and a plurality of the insulation members 14 are assembled in a net-like shape in a plan view, whereby a structure 31 shown in FIG. 2A is assembled.

Subsequently, anodization (alumite treatment) is performed on the structure 31 in FIG. 2A. Specifically, the structure 31 in FIG. 2A is immersed in an organic acid solution or an inorganic acid solution of sulfuric acid, oxalic acid, phosphoric acid, boric acid, or the like, and an appropriate voltage (1 to 500 V) is applied under a condition of 0° C. to ° C. Accordingly, a film of a dielectric body 13b made of aluminum oxide (alumina) is formed on the surface of the electrically-conductive member 13a made of aluminum. The dielectric body 13b has an electric insulation property. A conductor wire 13 is formed by the electrically-conductive member 13a and the dielectric body 13b formed on the surface of the electrically-conductive member 13a. The diameter of the conductor wire 13 is 0.1 mm to 2 mm, for example. The thickness of the dielectric body 13b is 20 nm to 10 μm, for example.

Since the insulation member 14 is formed from a resin material, the insulation member 14 does not react with the anodization, and hardly changes before and after the anodization.

Since an end portion on the X-axis negative side of each electrically-conductive member 13a is connected to a circuit, it is preferable that the dielectric body 13b is not formed at the end portion on the X-axis negative side of the electrically-conductive member 13a. Therefore, the anodization is performed such that the end portion on the X-axis negative side of the electrically-conductive member 13a is not immersed in the solution for anodization.

Thus, the anodization (alumite treatment) is performed on the structure 31 in FIG. 2A, whereby the structure 32 having a net-like shape is completed as shown in FIG. 2B.

With reference back to FIG. 1B, the structure 32 shown in FIG. 2B is disposed so as to be superposed on the upper face of the three electrically-conductive elastic bodies 12 shown in FIG. 1A. Subsequently, two conductor wires 13 adjacent to each other in the Y-axis direction are set on the base member 11 by threads 15. In the example shown in FIG. 1B, twelve threads 15 connect the conductor wires 13 to the base member 11 at positions other than the positions where the electrically-conductive elastic bodies 12 and the conductor wires 13 overlap each other. Each thread 15 is implemented by a chemical fiber, a natural fiber, a mixed fiber of the chemical fiber and the natural fiber, or the like.

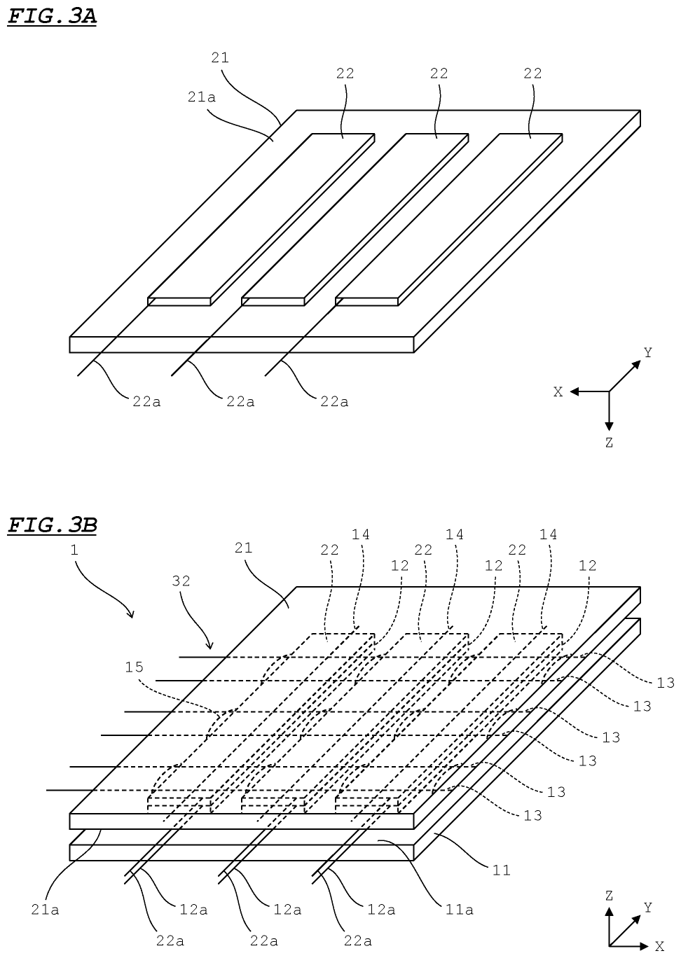

FIG. 3A is a perspective view schematically showing a base member 21 disposed so as to be superposed on the upper side of the base member 11, and electrically-conductive elastic bodies 22 set on an opposing face 21a (the face on the Z-axis negative side) of the base member 21.

The base member 21 has the same size and shape as those of the base member 11, and is formed from the same material as that of the base member 11. The electrically-conductive elastic bodies 22 are formed, on the opposing face 21a (the face on the Z-axis negative side) of the base member 21, at positions opposing the electrically-conductive elastic bodies 12, and are formed so as to be arranged with a predetermined interval therebetween in the X-axis direction. Each electrically-conductive elastic body 22 has the same size and shape as those of the electrically-conductive elastic body 12, and is formed from the same material as that of the electrically-conductive elastic body 12. Similar to the electrically-conductive elastic body 12, the electrically-conductive elastic body 22 is formed on the face on the Z-axis negative side of the base member 21 by a predetermined printing method. At an end portion on the Y-axis negative side of each electrically-conductive elastic body 22, a cable 22a electrically connected to the electrically-conductive elastic body 22 is set.

FIG. 3B is a perspective view schematically showing a state where the structure in FIG. 3A is set on the structure in FIG. 1B.

The structure shown in FIG. 3A is disposed from above (the Z-axis positive side) the structure shown in FIG. 1B. At this time, the base member 11 and the base member 21 are disposed such that: the opposing face 11a and the opposing face 21a face each other; and the electrically-conductive elastic bodies 12 and the electrically-conductive elastic bodies 22 are disposed so as to be superposed with each other. Then, the outer peripheral four sides of the base member 21 are connected to the outer peripheral four sides of the base member 11 with a silicone rubber-based adhesive, a thread, or the like, whereby the base member 11 and the base member 21 are fixed to each other. Accordingly, the structure 32 (the six conductor wires 13 and the three insulation members 14) is sandwiched by the three electrically-conductive elastic bodies 12 and the three electrically-conductive elastic bodies 22. Thus, as shown in FIG. 3B, the load sensor 1 is completed.

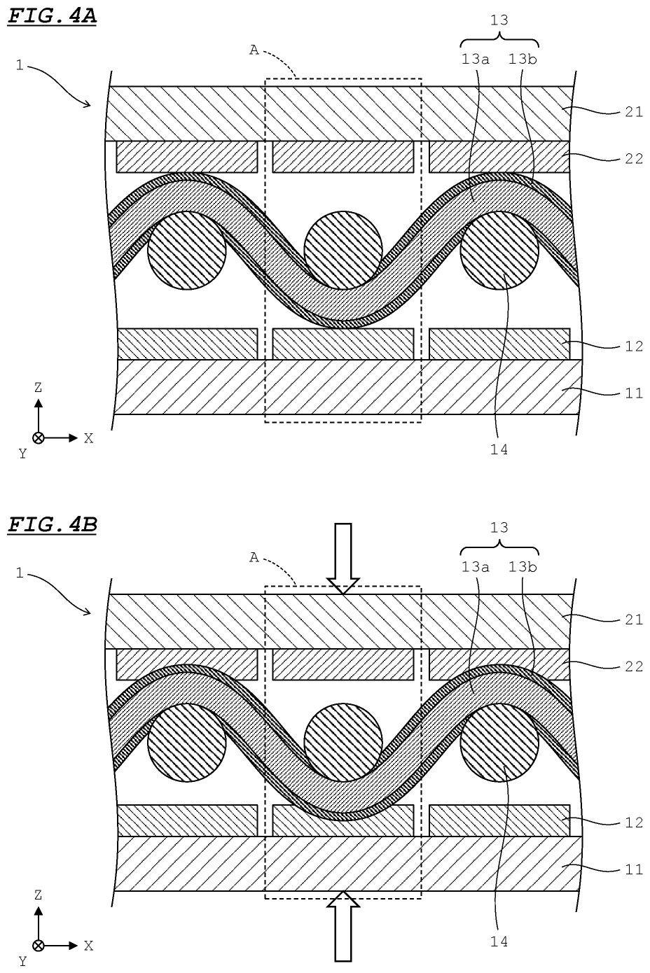

FIGS. 4A, 4B are each a cross-sectional view schematically showing the vicinity of an intersection between the electrically-conductive elastic bodies 12, 22 and the conductor wire 13 when viewed in the Y-axis positive direction. FIG. 4A shows a state where no load is applied, and FIG. 4B shows a state where loads are applied.

As shown in FIGS. 4A, 4B, in the direction (the X-axis direction) in which the conductor wire 13 extends, the conductor wire 13 and the electrically-conductive member 13a have a shape (oscillation shape) meandering in the up-down direction by being supported by the insulation members 14. That is, the conductor wire 13 and the electrically-conductive member 13a have a shape in which a bent shape that is bent in a direction toward the electrically-conductive elastic body 12, and a bent shape that is bent in a direction toward the electrically-conductive elastic body 22 are alternately arranged in the X-axis direction. The insulation members 14 maintain the bent shapes of the conductor wire 13.

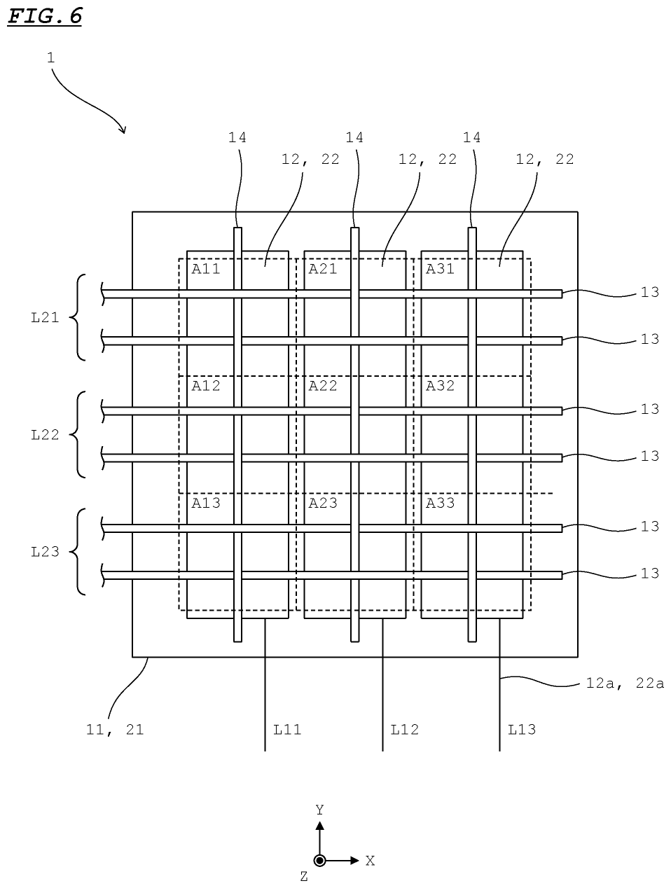

The vicinity of the intersection between electrically-conductive elastic bodies 12, 22 and a conductor wire 13 corresponds to one sensor part A where the capacitance changes in accordance with the load. A plurality of the sensor parts A are provided in a measurement region of the load sensor 1. Disposition of the sensor parts A will be described later with reference to FIG. 6.

As shown in FIG. 4A, when no load is applied, the force applied between the electrically-conductive elastic body 12 and the conductor wire 13 and the force applied between the electrically-conductive elastic body 22 and the conductor wire 13 are substantially zero. From this state, as shown in FIG. 4B, when a load is applied in the upward direction to the lower face of the base member 11 corresponding to a sensor part A, and a load is applied in the downward direction to the upper face of the base member 21 corresponding to the sensor part A, the electrically-conductive elastic bodies 12, 22 are deformed by the conductor wire 13.

As shown in FIG. 4B, when a load is applied to a sensor part A where the conductor wire 13 is bent in a direction toward the electrically-conductive elastic body 12, the conductor wire 13 is brought close to the electrically-conductive elastic body 12 so as to be wrapped by the electrically-conductive elastic body 12, and the contact area between the conductor wire 13 and the electrically-conductive elastic body 12 increases. Similarly, when a load is applied to a sensor part A where the conductor wire 13 is bent in a direction toward the electrically-conductive elastic body 22, the conductor wire 13 is brought close to the electrically-conductive elastic body 22 so as to be wrapped by the electrically-conductive elastic body 22, and the contact area between the conductor wire 13 and the electrically-conductive elastic body 22 increases.

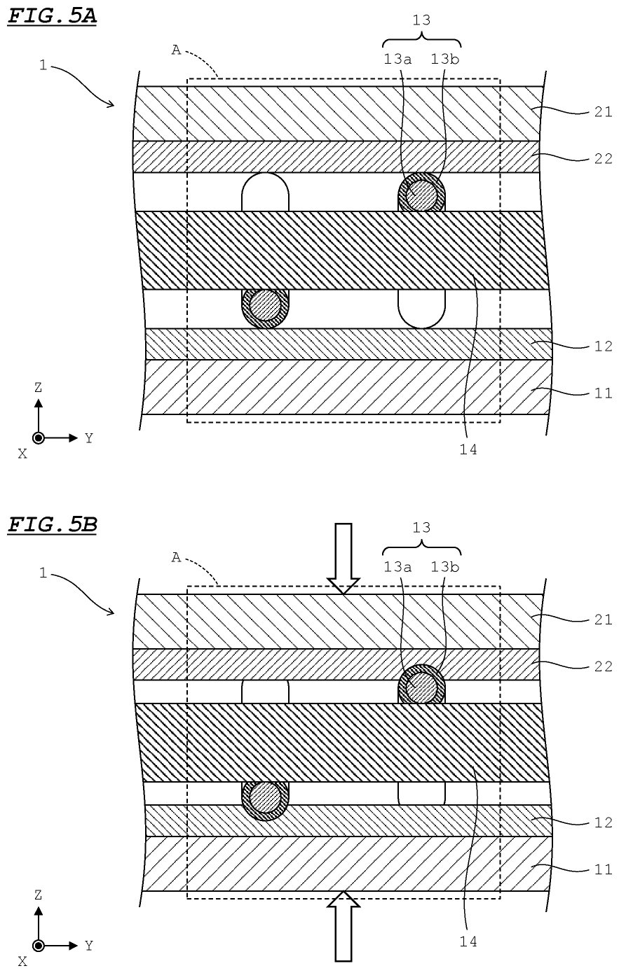

FIGS. 5A, 5B are each a cross-sectional view schematically showing the vicinity of an intersection between the electrically-conductive elastic bodies 12, 22 and the conductor wires 13 when viewed in the X-axis negative direction. FIG. 5A shows a state where no load is applied, and FIG. 5B shows a state where loads are applied.

The vicinity of an intersection between the electrically-conductive elastic bodies 12, 22 and adjacent two conductor wires 13 corresponds to one sensor part A.

As shown in FIG. 5A, when no load is applied to the sensor part A, the force applied between the electrically-conductive elastic body 12 and each conductor wire 13 and the force applied between the electrically-conductive elastic body 22 and each conductor wire 13 are substantially zero. From this state, as shown in FIG. 5B, when a load is applied in the upward direction to the lower face of the base member 11 corresponding to the sensor part A, and a load is applied in the downward direction to the upper face of the base member 21 corresponding to the sensor part A, the electrically-conductive elastic bodies 12, 22 are deformed by the conductor wires 13.

As shown in FIG. 5B, when loads are applied to the sensor part A, the conductor wire 13 positioned between the electrically-conductive elastic body 12 and the insulation member 14 is brought close to the electrically-conductive elastic body 12 so as to be wrapped by the electrically-conductive elastic body 12, and the contact area between the conductor wire 13 and the electrically-conductive elastic body 12 increases. On the other hand, the conductor wire 13 positioned between the electrically-conductive elastic body 22 and the insulation member 14 is brought close to the electrically-conductive elastic body 22 so as to be wrapped by the electrically-conductive elastic body 22 and the contact area between the conductor wire 13 and the electrically-conductive elastic body 22 increases.

As shown in FIG. 4B and FIG. 5B, when loads are applied to the sensor part A, the contact area between the conductor wire 13 and the electrically-conductive elastic body 12 and the contact area between the conductor wire 13 and the electrically-conductive elastic body 22 change in the circumferential direction and the length direction of the conductor wire 13. Accordingly, in accordance with the load, the capacitance between the electrically-conductive member 13a and the electrically-conductive elastic body 12 and the capacitance between the electrically-conductive member 13a and the electrically-conductive elastic body 22 change. Then, the capacitance in the sensor part A is detected, whereby the load applied to the sensor part A is calculated.

FIG. 6 is a plan view schematically showing a configuration of the inside of the load sensor 1 when viewed in the Z-axis negative direction. In FIG. 6, the threads 15 are not shown for convenience.

In the measurement region of the load sensor 1, nine sensor parts arranged in the X-axis direction and the Y-axis direction are set. Specifically, nine regions obtained by dividing the measurement region into three in the X-axis direction and dividing the measurement region into three in the Y-axis direction are assigned as the nine sensor parts. The boundary of each sensor part is in contact with the boundary of a sensor part adjacent thereto. The nine sensor parts correspond to nine positions where the electrically-conductive elastic bodies 12, 22 and adjacent two conductor wires 13 (a pair of conductor wires 13) cross each other, and each have a configuration similar to that of the sensor part A shown in FIG. 4A to FIG. 5B. In FIG. 6, at the nine positions, nine sensor parts A11, A12, A13, A21, A22, A23, A31, A32, A33 in each of which the capacitance changes in accordance with the load are formed.

Each sensor part includes electrically-conductive elastic bodies 12, 22 and a pair of conductor wires 13. The pair of conductor wires 13 forms one pole (e.g., positive pole) for capacitance, and the electrically-conductive elastic bodies 12, 22 form the other pole (e.g., negative pole) for capacitance. That is, the electrically-conductive members 13a (see FIG. 4A to FIG. 5B) in the pair of conductor wires 13 form one electrode of the load sensor 1 (capacitance-type load sensor), the electrically-conductive elastic bodies 12, 22 form the other electrode of the load sensor 1 (capacitance-type load sensor), and the dielectric bodies 13b (see FIG. 4A to FIG. 5B) in the pair of conductor wires 13 correspond to a dielectric body that defines the capacitance in the load sensor 1 (capacitance-type load sensor).

When a load is applied in the Z-axis direction to each sensor part, one of the pair of conductor wires 13 is wrapped by the electrically-conductive elastic body 12, and the other is wrapped by the electrically-conductive elastic body 22. Accordingly, the contact areas between the pair of conductor wires 13 and the electrically-conductive elastic bodies 12, 22 change, and the capacitances between the pair of conductor wires 13 and the electrically-conductive elastic bodies 12, 22 change.

End portions on the X-axis negative side of each pair of conductor wires 13, an end portion on the Y-axis negative side of each cable 12a, and an end portion on the Y-axis negative side of each cable 22a are connected to a detection circuit provided for the load sensor 1. The electrically-conductive members 13a in the pair of conductor wires 13 are connected to each other in the detection circuit, and the cables 12a, 22a are connected to each other in the detection circuit.

As shown in FIG. 6, the cables 12a, 22a drawn from the three sets of electrically-conductive elastic bodies 12, 22 will be referred to as lines L11, L12, L13, and the electrically-conductive members 13a in the three pairs of conductor wires 13 will be referred to as lines L21, L22, L23. The positions where the electrically-conductive elastic bodies 12, 22 connected to the line L11 cross the lines L21, L22, L23 are the sensor parts A11, A12, A13, respectively. The positions where the electrically-conductive elastic bodies 12, 22 connected to the line L12 cross the lines L21, L22, L23 are the sensor parts A21, A22, A23, respectively. The positions where the electrically-conductive elastic bodies 12, 22 connected to the line L13 cross the lines L21, L22, L23 are the sensor parts A31, A32, A33, respectively.

When a load is applied to the sensor part A11, the contact areas between the pair of conductor wires 13 and the electrically-conductive elastic bodies 12, 22 increase in the sensor part A11. Therefore, when the capacitance between the line L11 and the line L21 is detected, the load applied to the sensor part A11 can be calculated. Similarly, in another sensor part as well, when the capacitance between two lines crossing each other in the other sensor part is detected, the load applied to the other sensor part can be calculated.

Next, verification of the relationship between the load and the capacitance performed by the inventors will be described.

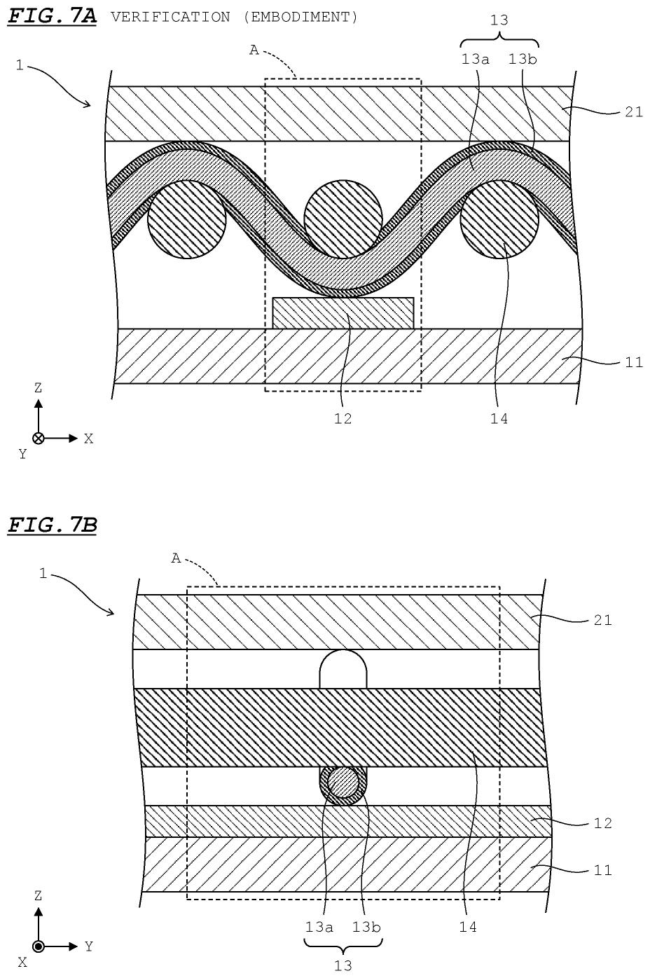

FIGS. 7A, 7B each schematically show a configuration of the load sensor 1 of an embodiment used in the verification. FIGS. 7A, 7B are cross-sectional views schematically showing the vicinity of an intersection between the electrically-conductive elastic body 12 and the conductor wire 13 when viewed in the Y-axis positive direction and in the X-axis negative direction, respectively.

As shown in FIGS. 7A, 7B, in the load sensor 1 of the embodiment used in the verification, one electrically-conductive elastic body 12 was disposed on the base member 11, and the electrically-conductive elastic body 22 on the base member 21 side was omitted. One conductor wire 13 was disposed between the electrically-conductive elastic body 12 and the base member 21. The diameter of the conductor wire 13 was set to 0.3 mm. In this experiment, only one sensor part A was formed.

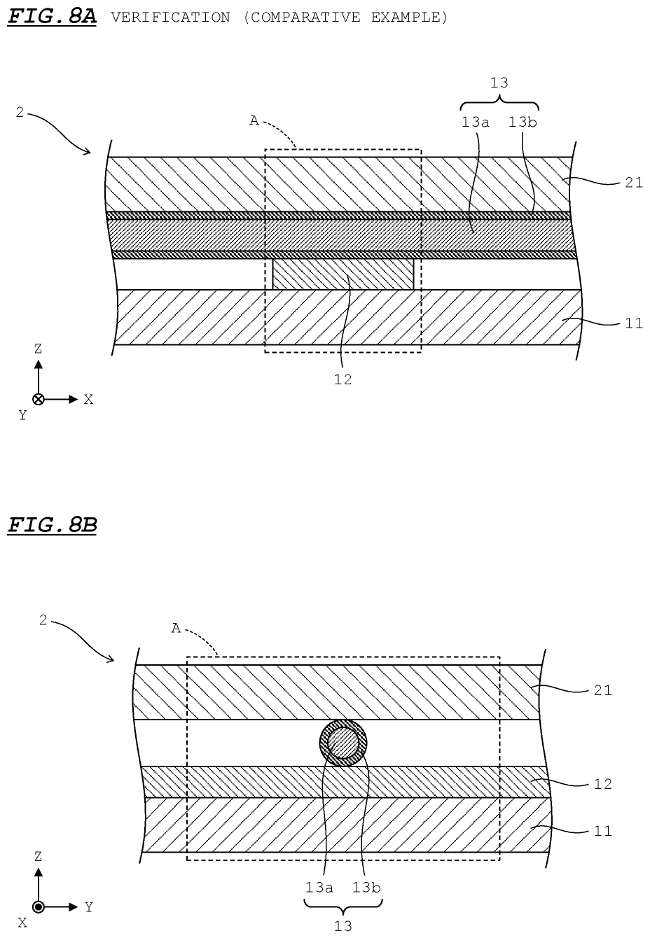

FIGS. 8A, 8B each schematically show a configuration of a load sensor 2 of Comparative Example used in the verification. FIGS. 8A, 8B are each a cross-sectional view schematically showing the vicinity of an intersection between the electrically-conductive elastic body 12 and the conductor wire 13 when viewed in the Y-axis positive direction and in the X-axis negative direction, respectively.

As shown in FIGS. 8A, 8B, in the load sensor 2 of Comparative Example used in the verification, the insulation member 14 is omitted and the conductor wire 13 extends in a straight line shape in the X-axis direction when compared with the configuration in FIGS. 7A, 7B.

The capacitance between the electrically-conductive elastic body 12 and the electrically-conductive member 13a was calculated through simulation during load application, with a load applied to the load sensor 1 in FIGS. 7A, 7B and the load sensor 2 in FIGS. 8A, 8B. In addition, the load sensor 2 in FIGS. 8A, 8B was actually created, and a load was actually applied to the created load sensor 2, and the capacitance between the electrically-conductive elastic body 12 and the electrically-conductive member 13a was measured during load application.

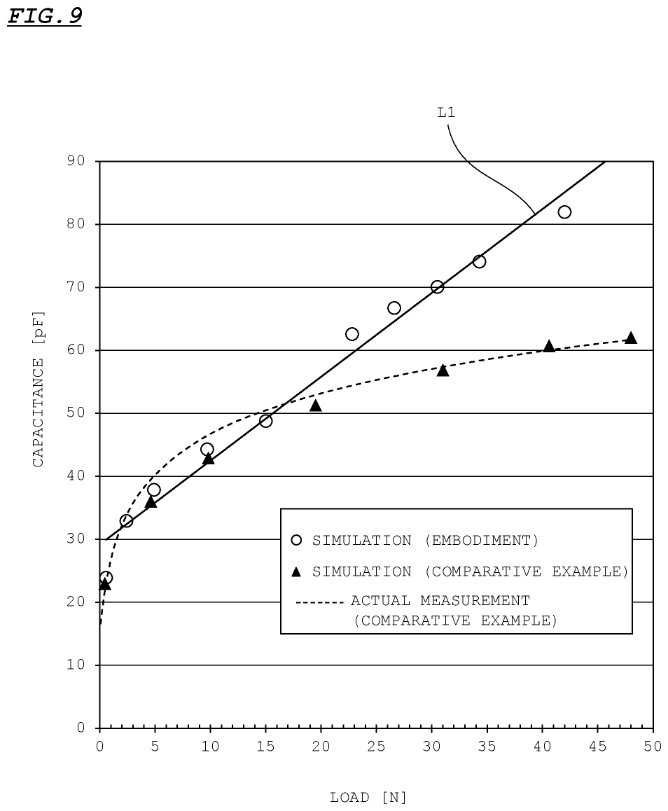

FIG. 9 is a graph showing a relationship between the load and the capacitance obtained in the verification. The horizontal axis shows load (N) and the vertical axis shows capacitance (pF)

As shown in FIG. 9, according to the actual measurement based on the load sensor 2 of Comparative Example in FIGS. 8A, 8B, the relationship between the load and the capacitance had a curved shape. According to the simulation based on the load sensor 2 of Comparative Example, the relationship between the load and the capacitance was generally distributed on a curve based on the actual measurement of Comparative Example. Thus, according to the load sensor 2 of Comparative Example, the relationship between the load and the capacitance was found to have a curved shape. When the relationship between the load and the capacitance has a curved shape like this, change in the capacitance according to the load is difficult to be appropriately detected through simple processing.

In the case of Comparative Example, the inflection point of the curve representing the relationship between the load and the capacitance is positioned near 5N to 8N. When the applied load reaches the inflection point, even if a load is further applied, the capacitance hardly increases any longer, and the state of change in the capacitance becomes a saturated state. In Comparative Example, the inflection point is at a value as small as 5N to 8N, and thus, the dynamic range of the detectable load is narrow.

Meanwhile, according to the simulation based on the load sensor 1 of the embodiment in FIGS. 7A, 7B, the relationship between the load and the capacitance was generally distributed on a straight line L1 in FIG. 9. When the relationship between the load and the capacitance has a straight line shape like this, change in the capacitance according to the load can be appropriately detected through simple processing.

In the case of the embodiment, when the relationship between the load and the capacitance is approximated to a curve, the inflection point of the curve is positioned at a value larger than 50 N. Therefore, in the embodiment, since the inflection point has a large value when compared with that in Comparative Example, the dynamic range of the detectable load is wide when compared with that in Comparative Example.

<Effects of Embodiment 1>

According to Embodiment 1, the following effects are exhibited.

The electrically-conductive member 13a has a bent shape that is bent in a direction toward the electrically-conductive elastic body 12. In a case where the electrically-conductive member 13a has the bent shape, when a load is applied, the electrically-conductive elastic body 12 is not only deformed in the circumferential direction (the Y-axis direction) of the electrically-conductive member 13a as shown in FIG. 5B, but also deformed, along the bent shape, in the length direction (the X-axis direction) of the electrically-conductive member 13a as shown in FIG. 4B. Thus, since the electrically-conductive elastic body 12 is deformed not only in the Y-axis direction but also in the X-axis direction due to the bent shape of the electrically-conductive member 13a, change in the contact area between the conductor wire 13 and the electrically-conductive elastic body 12 becomes gentler, and change in the contact area occurs in a wider load range. Therefore, when compared with a case where the electrically-conductive member 13a is not bent, change in the capacitance with respect to the load is less likely to be saturated, and the form of this change can be made closer to that of a straight line.

Thus, since the form of the relationship between the load and the capacitance is made close to that of a straight line, change in the capacitance according to the load can be appropriately detected through simple processing. Since change in the contact area between the conductor wire 13 and the electrically-conductive elastic body 12 occurs in a wide load range, the range up to the inflection point becomes wide as described with reference to FIG. 9, and the dynamic range of the detectable load can be widened.

The electrically-conductive elastic body 22 is disposed on the opposing face 21a of the base member 21 so as to be opposed to the electrically-conductive elastic body 12, and the electrically-conductive member 13a has a bent shape that is bent in a direction toward the electrically-conductive elastic body 22. Accordingly, at the position where the electrically-conductive elastic body 12 and the bent shape of the electrically-conductive member 13a toward the electrically-conductive elastic body 12 overlap each other, and in addition, at the position where the electrically-conductive elastic body 22 and the bent shape of the electrically-conductive member 13a toward the electrically-conductive elastic body 22 overlap each other, the load can be detected. In Embodiment 1, as shown in FIG. 6, the bent shape that is bent in a direction toward the electrically-conductive elastic body 12 and the bent shape that is bent in a direction toward the electrically-conductive elastic body 22 are included in one sensor part. In this case, the capacitance can be detected in the range of the two bent shapes, and thus, the detection sensitivity of the sensor part can be increased when compared with that in a case where one bent shape is included in the sensor part. When the two bent shapes are respectively included in separate sensor parts, increase in the detection position can be realized.

A plurality of the electrically-conductive elastic bodies 12 are disposed at a predetermined interval on the opposing face 11a of the base member 11, and the electrically-conductive member 13a is disposed so as to cross the plurality of the electrically-conductive elastic bodies 12. At least one said bent shape of the electrically-conductive member 13a that is bent in a direction toward the electrically-conductive elastic body 12 is disposed for each electrically-conductive elastic body 12. Thus, at a plurality of positions at each of which the bent shape of the electrically-conductive member 13a overlaps the electrically-conductive elastic body 12, loads can be individually detected. Similarly, a plurality of the electrically-conductive elastic bodies 22 are disposed at a predetermined interval on the opposing face 21a of the base member 21, and the electrically-conductive member 13a is disposed so as to cross the plurality of the electrically-conductive elastic bodies 22. At least one said bent shape of the electrically-conductive member 13a that is bent in a direction toward the electrically-conductive elastic body 22 is disposed for each electrically-conductive elastic body 22. Thus, at a plurality of positions at each of which the bent shape of the electrically-conductive member 13a overlaps the electrically-conductive elastic body 22, loads can be individually detected.

Each electrically-conductive elastic body 12 has a band-like shape that is long in a direction (the Y-axis direction) that crosses a direction (the X-axis direction) in which the electrically-conductive member 13a extends, and a plurality of the electrically-conductive members 13a are disposed so as to cross the electrically-conductive elastic body 12. Accordingly, at a plurality of positions at each of which the bent shape, of each electrically-conductive member 13a, that is bent in a direction toward the electrically-conductive elastic body 12 overlaps the electrically-conductive elastic body 12, loads can be individually detected. Similarly, each electrically-conductive elastic body 22 has a band-like shape that is long in a direction (the Y-axis direction) that crosses a direction (the X-axis direction) in which the electrically-conductive member 13a extends, and a plurality of the electrically-conductive members 13a are disposed so as to cross the electrically-conductive elastic body 22. Accordingly, at a plurality of positions at each of which the bent shape, of each electrically-conductive member 13a, that is bent in a direction toward the electrically-conductive elastic body 22 overlaps the electrically-conductive elastic body 22, loads can be individually detected.

The insulation member 14 is a member, having a linear shape, that crosses the electrically-conductive member 13a and maintains the bent shape of the electrically-conductive member 13a. Thus, the bent shape of the electrically-conductive member 13a can be assuredly maintained.

A plurality of the electrically-conductive members 13a and a plurality of the insulation members 14 form a net. At a plurality of intersections at each of which an electrically-conductive member 13a and an insulation member 14 cross each other, the intersection 41 (see FIG. 2A) at which an electrically-conductive member 13a is positioned below (the Z-axis negative side) an insulation member 14, and the intersection 42 (see FIG. 2A) at which an electrically-conductive member 13a is positioned above (the Z-axis positive side) an insulation member 14 are alternately disposed in the direction (the X-axis direction) in which the electrically-conductive member 13a extends and in the direction (the Y-axis direction) in which the insulation member 14 extends. Accordingly, the bent shapes can be easily formed in the electrically-conductive members 13a.

The dielectric body 13b is set so as to cover the surface of the electrically-conductive member 13a. With this configuration, the dielectric body 13b can be set between the electrically-conductive elastic bodies 12, 22 and the electrically-conductive member 13a by merely covering the surface of the electrically-conductive member 13a with the dielectric body 13b.

The electrically-conductive member 13a is formed from aluminum and the dielectric body 13b is formed from aluminum oxide. Thus, when the dielectric body 13b is formed from an oxide that includes the same composition as that of the electrically-conductive member 13a, the interface strength between the electrically-conductive member 13a and the dielectric body 13b becomes strong, and thus, the dielectric body 13b is less likely to be detached from the electrically-conductive member 13a due to the stress during load application. Therefore, the reliability of the load sensor 1 can be increased. In addition, the surface of the electrically-conductive member 13a can be inexpensively and speedily covered with the dielectric body 13b through a simple process (alumite treatment).

The dielectric body 13b is formed from aluminum oxide having a relative permittivity of about 8.5. Thus, when dielectric body 13b is formed from a material having a relative permittivity that is greater than 3.5, the capacitance between the electrically-conductive elastic body 12, 22 and the electrically-conductive member 13a is increased. Therefore, the sensitivity characteristic of the load sensor 1 can be increased.

As shown in FIG. 2A, by merely assembling the electrically-conductive members 13a and the insulation members 14 to form the structure 31, and performing anodization on the structure 31, it is possible to form the structure 32 on which the conductor wires 13 are disposed according to a layout, as shown in FIG. 2B. Thus, complicated work such as individually immersing a plurality of the electrically-conductive members 13a into a solution for anodization to form the conductor wires 13 and appropriately disposing the conductor wires 13 on the structure in FIG. 1A is not necessary. With the structure 32 shown in FIG. 2B, disposition of the conductor wires 13 is completed by merely disposing the structure 32 on the structure in FIG. 1A. Therefore, assembly of the load sensor 1 can be simplified.

### Embodiment 2

In Embodiment 1 above, the electrically-conductive elastic body 22 is disposed between the conductor wire 13 and the base member 21. However, in Embodiment 2, the electrically-conductive elastic body 22 is omitted.

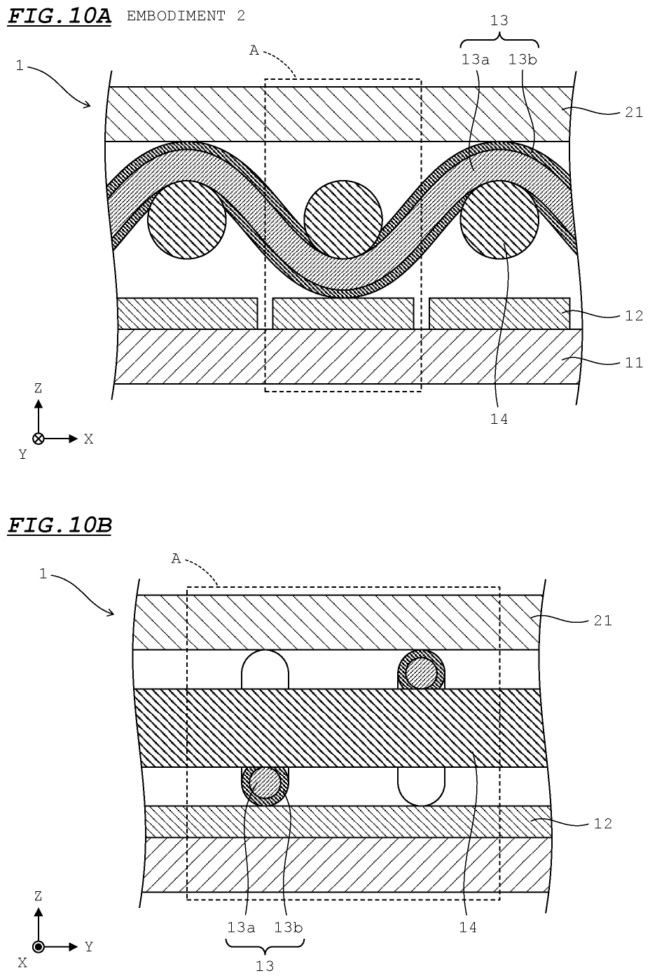

FIGS. 10A, 10B are each a cross-sectional view schematically showing the vicinity of an intersection between the electrically-conductive elastic body 12 and the conductor wire 13, according to Embodiment 2.

As shown in FIG. 10A, at the position where the conductor wire 13 is bent in a direction toward the electrically-conductive elastic body 12, the capacitance between the electrically-conductive member 13a and the electrically-conductive elastic body 12 changes in accordance with the load.

However, at the position where the conductor wire 13 is bent in a direction toward the base member 21, the capacitance between the electrically-conductive member 13a and the electrically-conductive elastic body 12 does not change in accordance with the load.

However, as shown in FIG. 10B, in Embodiment 2, one sensor part A includes two conductor wires 13 as in Embodiment 1. Therefore, although the load cannot be detected from one conductor wire 13 in the sensor part A, the load can be detected from the other conductor wire 13 in the sensor part A.

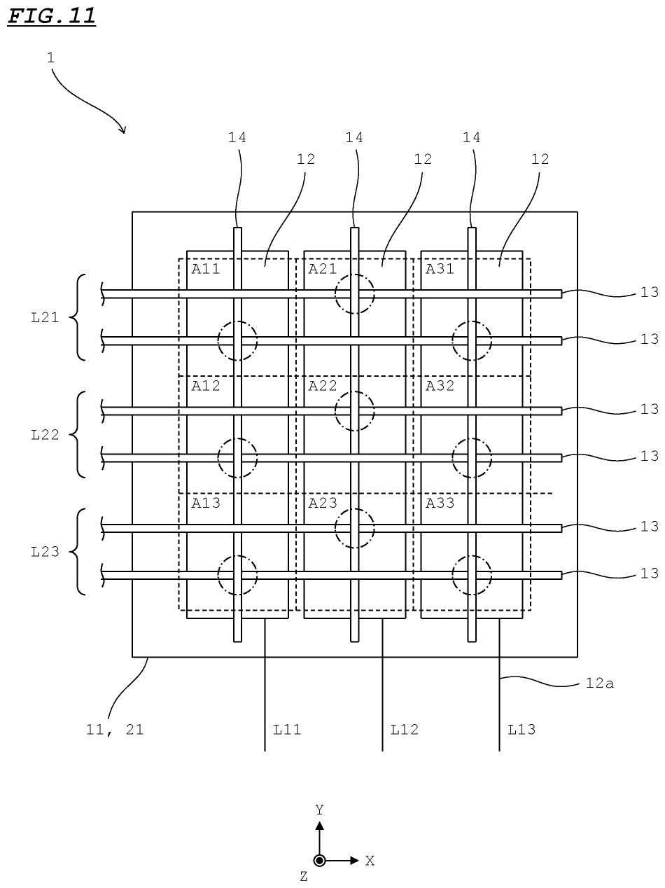

FIG. 11 is a plan view schematically showing a configuration of the inside of the load sensor 1 when viewed in the Z-axis negative direction, according to Embodiment 2.

In Embodiment 2, there is no electrically-conductive elastic body above the conductor wires 13. Therefore, as indicated by each circle of an alternate long and short dash line in FIG. 11, at the place where the conductor wire 13 passes on the lower side (the Z-axis negative side) of the insulation member 14, the capacitance changes in accordance with the load. Therefore, in Embodiment 2 as well, at each sensor part, the load can be detected in accordance with change in the capacitance at each place indicated by the circle of the alternate long and short dash line.

However, when the electrically-conductive elastic body 22 is disposed between the conductor wire 13 and the base member 21 as in Embodiment 1, the sensitivity of the load sensor 1 can be increased since the capacitance changes at two intersections in one sensor part.

### Embodiment 3

In Embodiment 1 above, the insulation member 14 is formed from an acrylic resin or a nylon resin. However, in Embodiment 3, the insulation member 14 is formed from an insulation-coated metal.

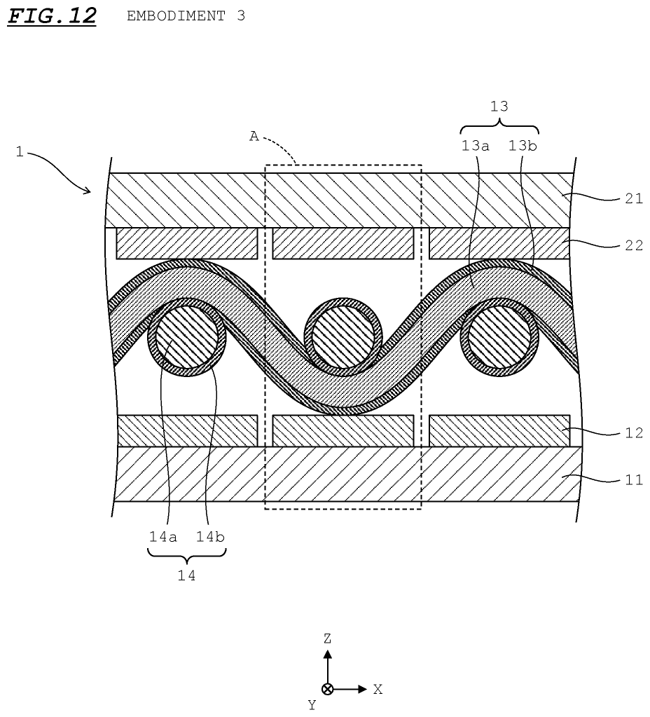

FIG. 12 is a cross-sectional view schematically showing the vicinity of an intersection between the electrically-conductive elastic bodies 12, 22 and the conductor wire 13, according to Embodiment 3.

The insulation member 14 is formed from a metal member 14a and a cover member 14b covering the surface of the metal member 14a. The cover member 14b is formed from an insulative material. The insulation member 14 is formed from an enameled wire, for example. In this case, the metal member 14a is formed from copper (Cu), and the cover member 14b is formed from polyurethane.

In Embodiment 3, in order to prevent the electrically-conductive member 13a from coming into contact with the metal member 14a to cause conduction therebetween, the metal member 14a is covered with the cover member 14b in advance before assembling the structure 31 shown in FIG. 2A, to create the insulation member 14. Then, the structure 31 is assembled as shown in FIG. 2A, and anodization is performed on the assembled structure 31, whereby the structure 32 shown in FIG. 2B is created.

In Embodiment 3 as well, the bent shape of the conductor wire 13 can be maintained by the insulation member 14.

### Embodiment 4

In Embodiment 1 above, in order to maintain the bent shape of the conductor wire 13, the insulation member 14 having a linear shape is used. However, in Embodiment 4, the insulation member 14 is omitted.

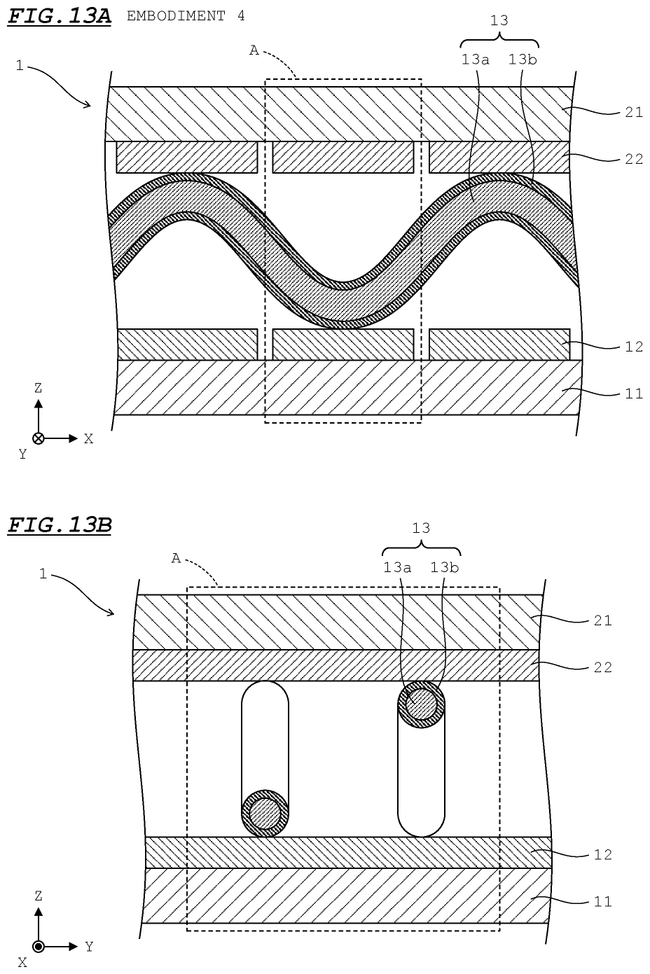

FIGS. 13A, 13B are each a cross-sectional view schematically showing the vicinity of an intersection between the electrically-conductive elastic bodies 12, 22 and the conductor wire 13, according to Embodiment 4.

As shown in FIGS. 13A, 13B, the conductor wire 13 of Embodiment 4 has a shape similar to that of the bent shape of the conductor wire 13 held by the insulation members 14 in Embodiment 1.

In Embodiment 4, before assembling the load sensor 1, the electrically-conductive member 13a is deformed so as to have a bent shape similar to that of the electrically-conductive member 13a of Embodiment 1 above. The electrically-conductive member 13a is formed from a material having high rigidity so as to be able to maintain the bent shape. Then, anodization is individually performed on a plurality of the electrically-conductive members 13a, whereby the dielectric body 13b is formed on each electrically-conductive member 13a, and the conductor wire 13 is created. The plurality of the conductor wires 13 are disposed on the structure in FIG. 1A so as to be disposed similarly to the conductor wires 13 in Embodiment 1.

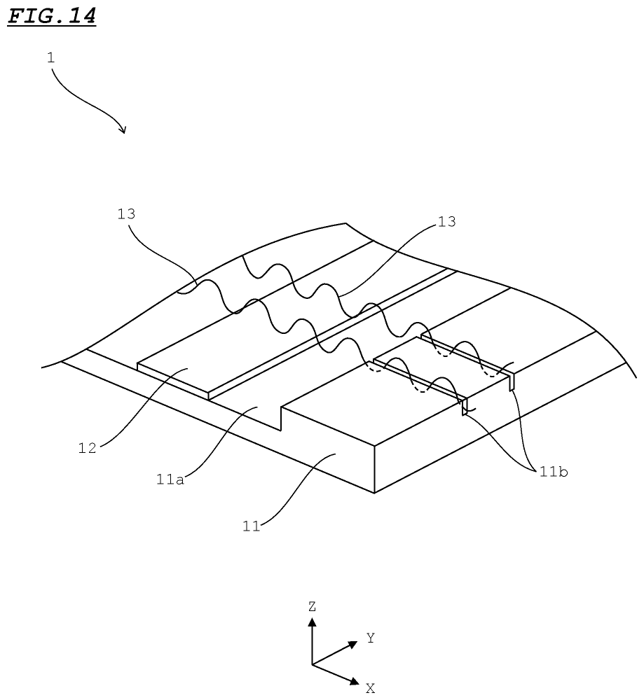

FIG. 14 is a perspective view schematically showing a configuration in which the conductor wires 13 are disposed. In FIG. 14, only the vicinity of an end portion of the base member 11 is shown, for convenience.

On the X-axis positive side of the opposing face 11a of the base member 11, grooves 11b extending in the X-axis direction along the disposition positions of the conductor wires 13 are formed. Similarly, also on the X-axis negative side of the opposing face 11a of the base member 11, grooves 11b extending in the X-axis direction along the disposition positions of the conductor wires 13 are formed. At the setting of each conductor wire 13, an end portion on the X-axis positive side of the conductor wire 13 is accommodated in the groove 11b on the X-axis positive side of the base member 11, and an end portion on the X-axis negative side of the conductor wire 13 is accommodated in the groove 11b on the X-axis negative side of the base member 11. Accordingly, the conductor wire 13 is inhibited from rotating about the X-axis, and the bending direction of the conductor wire 13 is maintained in the Z-axis direction. Then, the structure in FIG. 3A is set on the structure in FIG. 14, whereby the load sensor 1 is completed.

In Embodiment 4 as well, similar to Embodiment 1, the conductor wire 13 has a bent shape that is bent in a direction toward the electrically-conductive elastic body 12, 22, and thus, the electrically-conductive elastic body 12, 22 is deformed in both of the X-axis direction and the Y-axis direction. Therefore, the form of the relationship between the load and the capacitance can be made close to that of a straight line, and the detectable dynamic range can be widened.

### Embodiment 5

In Embodiment 1 above, the dielectric body 13b is formed on the surface of the electrically-conductive member 13a. However, as long as the dielectric body 13b is disposed between the electrically-conductive elastic body 12 and the electrically-conductive member 13a and between the electrically-conductive elastic body 22 and the electrically-conductive member 13a, the dielectric body 13b need not necessarily be disposed on the surface of the electrically-conductive member 13a. In Embodiment 5, the dielectric body 13b is disposed on the surfaces of the electrically-conductive elastic bodies 12, 22.

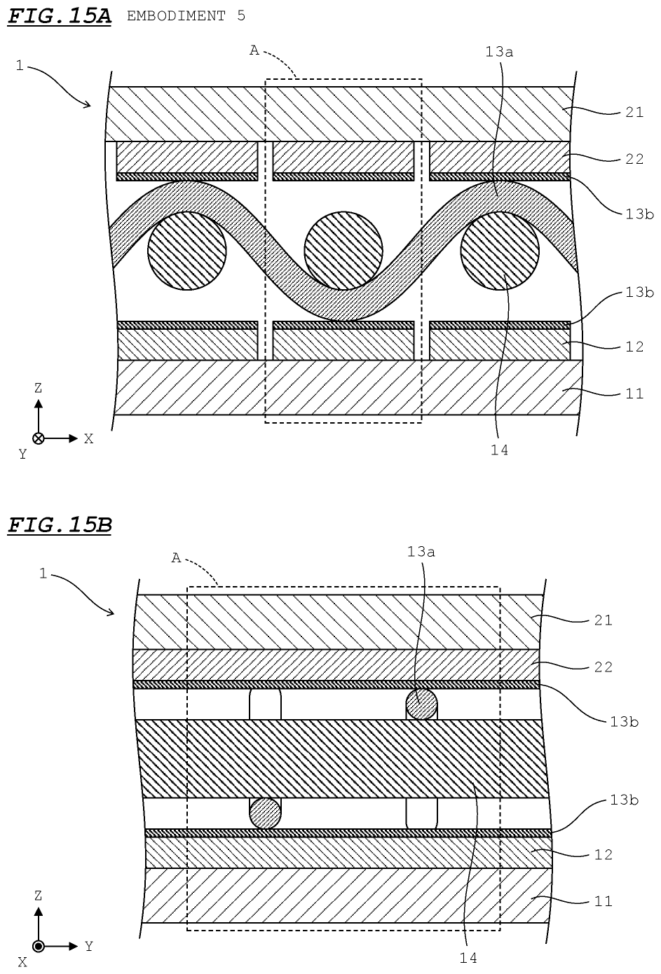

FIGS. 15A, 15B are each a cross-sectional view schematically showing the vicinity of an intersection between the electrically-conductive elastic bodies 12, 22 and the electrically-conductive member 13a, according to Embodiment 5. As shown in FIGS. 15A, 15B, in Embodiment 5, when compared with Embodiment 1, the dielectric body 13b is omitted from the conductor wire 13, and the dielectric body 13b is formed on each of the opposing face (upper face) of the electrically-conductive elastic body 12 and the opposing face (lower face) of the electrically-conductive elastic body 22. The dielectric body 13b of Embodiment 5 is formed from a resin material or the like, and is typically formed from urethane.

In Embodiment 5, when a load is applied to the load sensor 1, the electrically-conductive elastic bodies 12, 22 are not only deformed in the circumferential direction (the Y-axis direction) of the electrically-conductive member 13a, but also deformed, along the bent shape, in the length direction (the X-axis direction) of the electrically-conductive member 13a. Thus, since the electrically-conductive elastic bodies 12, 22 are deformed not only in the Y-axis direction but also in the X-axis direction due to the bent shape of the electrically-conductive member 13a, change in the contact area between the electrically-conductive member 13a and the dielectric body 13b becomes gentler and occurs in a wide load range. Therefore, the form of the relationship between the load and the capacitance can be made close to that of a straight line, and the dynamic range of the detectable load can be widened.

<Modification>

The configuration of the load sensor 1 can be modified in various ways other than the configurations shown in the above embodiments.

For example, in Embodiments 1 to 5 above, the electrically-conductive member 13a is formed from aluminum, but may be formed from: a valve action metal such as titanium (Ti), tantalum (Ta), niobium (Nb), zirconium (Zr), or hafnium (Hf); tungsten (W); molybdenum (Mo); copper (Cu); nickel (Ni); silver (Ag); gold (Au); or the like.

In Embodiments 1 to 5 above, the dielectric body 13b only needs to be formed from a material having an electric insulation property, and may be formed from a material other than the above, such as a resin material, a ceramic material, a metal oxide material, or the like, for example.

In Embodiments 1 to 4 above, the dielectric body 13b is formed from aluminum oxide, but is not limited thereto. For example, when the electrically-conductive member 13a is formed from a valve action metal such as titanium, tantalum, niobium, zirconium, or hafnium, the dielectric body 13b may be formed from an oxide of the electrically-conductive member 13a. Thus, when the dielectric body 13b is an oxide that includes the same composition as that of the electrically-conductive member 13a, the dielectric body 13b is less likely to be detached from the electrically-conductive member 13a, and the reliability of the load sensor 1 can be increased.

In Embodiments 1 to 4 above, the dielectric body 13b need not necessarily be an oxide that includes the same composition as that of the electrically-conductive member 13a. For example, the electrically-conductive member 13a may be formed from copper, and the dielectric body 13b may be formed from aluminum oxide. However, in this case, the interface strength between the electrically-conductive member 13a and the dielectric body 13b is less likely to be strong. Therefore, preferably, the dielectric body 13b is an oxide that includes the same composition as that of the electrically-conductive member 13a.

In Embodiments 1 to 5 above, when the dielectric body 13b is an oxide of aluminum, the dielectric body 13b may contain S, P, and N in an amount of 0.1 to 10 atm % other than aluminum serving as the main component. In such a case, the durability of the dielectric body 13b itself is improved, and a crack or the like due to external pressure, impact, or the like can be inhibited. The dielectric body 13b that is amorphous is preferable because similar effects can be obtained.

In Embodiments 1 to 4 above, the dielectric body 13b is formed on the surface of the electrically-conductive member 13a through anodization (alumite treatment). However, the method of forming the dielectric body 13b is not limited thereto.

In Embodiment 3 above, the metal member 14a is formed from copper (Cu) and the cover member 14b is formed from polyurethane, but the present invention is not limited thereto. The metal member 14a may be formed from the above metals or the like that can be used for the electrically-conductive member 13a, and the cover member 14b may be formed from the above materials that can be used for the dielectric body 13b. As an example, the metal member 14a may be formed from aluminum and the cover member 14b may be formed from aluminum oxide.

As in FIGS. 2A, 2B, when the entirety of the structure 31 is immersed in the solution for anodization, the cover member 14b is formed from a material that does not undergo chemical change due to the solution for anodization. In a case where the cover member 14b undergoes chemical change due to the solution for anodization, the conductor wires 13 are individually created through anodization, and then, the conductor wires 13 and the insulation members 14 are assembled as in FIG. 2B, whereby the structure 32 is created.

In Embodiments 1 to 5 above, the load sensor 1 includes six conductor wires 13. However, the load sensor 1 only needs to include one or more conductor wires 13. For example, the number of conductor wires 13 included in the load sensor 1 may be one. In addition, although the sensor part of the load sensor 1 includes two conductor wires 13, the sensor part only needs to include one or more conductor wires 13. For example, the number of conductor wires 13 included in the sensor part may be one.

In Embodiments 1 and 3 to 5 above, the load sensor 1 includes three sets of the electrically-conductive elastic bodies 12, 22 opposed to each other in the up-down direction. However, the load sensor 1 only needs to include at least one set of the electrically-conductive elastic bodies 12, 22. For example, the number of sets of the electrically-conductive elastic bodies 12, 22 included in the load sensor 1 may be one. In Embodiment 4 above, the load sensor 1 includes three electrically-conductive elastic bodies 12. However, the load sensor 1 only needs to include at least one electrically-conductive elastic body 12. For example, the number of electrically-conductive elastic bodies 12 included in the load sensor 1 may be one.

In Embodiments 1, 3, 5 above, one insulation member 14 is disposed so as to correspond to one set of the electrically-conductive elastic bodies 12, 22 opposed to each other in the up-down direction. However, two or more insulation members 14 may be disposed so as to correspond to one set of the electrically-conductive elastic bodies 12, 22. That is, one sensor part may include two or more insulation members 14, and in a range including a bent shape in the downward direction of the electrically-conductive member 13a and a bent shape adjacent thereto in the upward direction, one set of the electrically-conductive elastic bodies 12 22 may be disposed. Similarly, in Embodiment 2 above as well, two or more insulation members 14 may be disposed so as to correspond to one electrically-conductive elastic body 12. In Embodiment 4 above, one bent shape is provided so as to correspond to one set of the electrically-conductive elastic bodies 12, 22 opposed to each other in the up-down direction. However, two or more bent shapes may be provided so as to correspond to one set of the electrically-conductive elastic bodies 12, 22.

In Embodiments 1 to 4 above, a pair of conductor wires 13 in the sensor part may be connected to each other at end portions on the X-axis positive side. For example, a pair of conductor wires 13 passing through one sensor part may be formed by bending one conductor wire 13 extending in the X-axis direction. In Embodiment 5 above, a pair of electrically-conductive members 13a in the sensor part may be connected to each other at end portions in the X-axis direction.

In Embodiments 1 to 5 above, the bent shape that is bent in the downward direction and the bent shape that is bent in the upward direction are alternately provided in the direction (the X-axis direction) in which the electrically-conductive member 13a extends. However, not limited thereto, in the direction in which the electrically-conductive member 13a extends, the bent shapes that are bent in the downward direction may be successively arranged, and the bent shapes that are bent in the upward direction may be successively arranged. When only the bent shapes that are bent in the downward direction are provided in the electrically-conductive member 13a, the electrically-conductive elastic body 12 may be provided only at the positions of the downwardly bent shapes. When only the bent shapes that are bent in the upward direction are provided in the electrically-conductive member 13a, the electrically-conductive elastic body 22 may be provided only at the positions of the upwardly bent shapes. Further, between the bent shapes adjacent to each other in the X-axis direction, a straight line portion of the electrically-conductive member 13a extending in a straight line shape may be disposed.

In Embodiments 1 to 5 above, the bent shape of the electrically-conductive member 13a is not limited to the shape shown in FIGS. 4A, 4B, FIG. 10A, FIG. 12, FIG. 13A, and FIG. 15A.

In Embodiments 1 and 3 to 5 above, the electrically-conductive elastic body 12, 22 and the electrically-conductive member 13a cross each other at 90° in a plan view, but may cross each other at an angle other than 90°. In Embodiment 2 above, the electrically-conductive elastic body 12 and the electrically-conductive member 13a cross each other at 90° in a plan view, but may cross each other at an angle other than 90°.

In Embodiments 1 to 3 and 5 above, the electrically-conductive member 13a and the insulation member 14 cross each other at 90° in a plan view, but may cross each other at an angle other than 90°.

In Embodiments 1 to 3 and 5 above, the diameter of the electrically-conductive member 13a may be larger than the diameter of the insulation member 14, or vice versa, or the diameter of the electrically-conductive member 13a and the diameter of the insulation member 14 may be equal to each other.

In Embodiments 1 to 5 above, the cross-sectional shape of the electrically-conductive member 13a is a circle, but the cross-sectional shape of the electrically-conductive member 13a is not limited to a circle, and may be another shape such as an ellipse, a pseudo circle, or the like. The electrically-conductive member 13a may be implemented as a twisted wire obtained by twisting a plurality of electrically-conductive members.

In Embodiments 1 to 3 and 5 above, the cross-sectional shape of the insulation member 14 is a circle, but the cross-sectional shape of the insulation member 14 is not limited to a circle, and may be another shape such as an ellipse, a pseudo circle, a shape obtained by rounding the corners of a rhombus, or the like. The diameter of the insulation member 14 is constant, but may be different depending on the position in the X-axis direction. For example, at a contact position between the insulation member 14 and the conductor wire 13 (or the electrically-conductive member 13a), the insulation member 14 may be thin.

In Embodiments 1 to 3 above, as shown in FIGS. 4A, 4B, FIG. 10A, and FIG. 12, at a position where the conductor wire 13 and the insulation member 14 cross each other, the electrically-conductive member 13a and the insulation member 14 come into contact with each other. However, not limited thereto, between the electrically-conductive member 13a and the insulation member 14, the dielectric body 13b may be formed on the electrically-conductive member 13a.

In Embodiments 1 to 5 above, the threads 15 shown in FIG. 3B may be omitted. Instead of the threads 15, another fixation tool may be used.

In addition to the above, various modifications can be made as appropriate to the embodiments of the present invention without departing from the scope of the technical idea defined by the claims.

What is claimed is:

1. A load sensor comprising:
a first base member and a second base member disposed so as to face each other;
an electrically-conductive elastic body disposed on an opposing face of the first base member;
an electrically-conductive member having a linear shape and disposed between the second base member and the electrically-conductive elastic body; and
a dielectric body disposed between the electrically-conductive elastic body and the electrically-conductive member, wherein
the electrically-conductive member has a bent shape that is bent in a direction toward the electrically-conductive elastic body.

2. The load sensor according to claim 1, wherein
a plurality of the electrically-conductive elastic bodies are disposed at a predetermined interval on the opposing face of the first base member,
the electrically-conductive member is disposed so as to cross the plurality of the electrically-conductive elastic bodies, and
at least one said bent shape of the electrically-conductive member is disposed for each of the electrically-conductive elastic bodies.

3. The load sensor according to claim 1, wherein
the electrically-conductive elastic body has a band-like shape that is long in a direction that crosses a direction in which the electrically-conductive member extends, and
a plurality of the electrically-conductive members are disposed so as to cross the electrically-conductive elastic body.

4. The load sensor according to claim 1, comprising
another electrically-conductive elastic body disposed on an opposing face of the second base member so as to be opposed to the electrically-conductive elastic body, wherein
the electrically-conductive member is disposed between the electrically-conductive elastic body and the other electrically-conductive elastic body, and has another bent shape that is bent in a direction toward the other electrically-conductive elastic body.

5. The load sensor according to claim 1, comprising
an insulation member, having a linear shape, that crosses the electrically-conductive member and maintains the bent shape of the electrically-conductive member.

6. The load sensor according to claim 5, wherein
a plurality of the electrically-conductive members and a plurality of the insulation members form a net, and
at a plurality of intersections at each of which the electrically-conductive member and the insulation member cross each other, an intersection at which the electrically-conductive member is positioned below the insulation member and an intersection at which the electrically-conductive member is positioned above the insulation member are alternately disposed in a direction in which the electrically-conductive member extends and in a direction in which the insulation member extends.

7. The load sensor according to claim 5, wherein
the insulation member is formed from a resin or an insulation-coated metal.

8. The load sensor according to claim 1, wherein
the dielectric body is set so as to cover a surface of the electrically-conductive member.

9. The load sensor according to claim 8, wherein
the electrically-conductive member is formed from aluminum, and
the dielectric body is formed from aluminum oxide.
